(19) United States
(12) Patent Application Publication
(10) Pub. No.: US 2006/0174110 A1
(43) Pub. Date: Aug. 3, 2006

(54) Symmetric key optimizations

(75) Inventors: Clifford P. Strom, Sammamish, WA (US); Benjamin Brooks Cutter, Kirkland, WA (US); Brian P. Evans, Redmond, WA (US); Aamer Hydrie, Seattle, WA (US); Kirt A. Debique, Seattle, WA (US)

Correspondence Address: MICROSOFT CORPORATION;ATTN: PATENT GROUP DOCKETING DEPARTMENT, ONE MICROSOFT WAY, REDMOND, WA, 98052-6399, US

(73) Assignee: Microsoft Corporation, Redmond, WA (US)

(21) Appl. No.: 11/048,194

(22) Filed: Jan. 31, 2005

(51) Int. Cl. H04L 9/00

(52) U.S. Cl. 713/165

(57) ABSTRACT

A method of indirect license acquisition. A method of indirect license acquisition comprising, requesting a device certificate from a CE device by a PC. Then validating the device certificate sent from the CE device by the PC. Creating a random session ID and a session key by the PC. Generating a sent license response that is sent to the CE device. And processing a license response by the CE device.

### DESCRIPTION OF THE DRAWINGS

The present invention will be better understood from the following detailed description read in light of the accompanying drawings, wherein:

FIG. 1 is a diagram of a digital rights management system that utilizes symmetric keys.

FIG. 2 illustrates the conventional process of asymmetric key operation.

FIG. 3 illustrates the process of symmetric key optimization to produce symmetric keys.

FIG. 4 pictorially illustrates the exchange between a PC and the CE device that utilizes symmetric keys produced by symmetric key optimization.

FIG. 5 is a flow diagram showing the process of the exchange between the PC and the CE device utilizing symmetric keys produced by symmetric key optimization.

FIG. 6 is a flow diagram showing the process of the exchange between the internet and the CE device utilizing symmetric keys produced by symmetric key optimization.

FIG. 7 illustrates an exemplary computing environment in which the systems and methods described in this application, may be implemented.

Like reference numerals are used to designate like parts in the accompanying drawings.

### DETAILED DESCRIPTION

The examples described below describe symmetric key optimizations (SKOs) which may be utilized in the process of acquiring digital rights management (“DRM”) licenses, playing DRM content and the like. Symmetric cryptographic operations tend to use the same key for encryption and decryption, and may be applied to the DRM processes of encryption, digital signatures, and the like that are used to acquire or play DRM content. SKOs may allow lower performance CPUs typically encountered in cost effective consumer devices to provide an efficient and secure transfer of content in a digital rights management system.

The detailed description provided below in connection with the appended drawings is intended as a description of the present examples of the invention and is not intended to represent the only forms in which the present invention may be constructed or utilized. The description sets forth the functions of the invention and the sequence of steps for constructing and operating the invention in connection with the examples illustrated. However, the same or equivalent functions and sequences may be accomplished by different examples of the invention.

Although the present invention is described and illustrated herein as being implemented in a consumer electronics (“CE”) system, the system described is provided as an example and not a limitation. CE devices may include pocket PCs, set top boxes, portable media centers, cell phones, music players, PCs, software constructed media players, and the like. As those skilled in the art will appreciate, the present invention is suitable for application in a variety of different types of systems that utilize licenses to regulate the playback of content. A typical system is a digital rights management (“DRM”) system. The use of a device certificate template may be useful in the individualization process typically used in these types of systems.

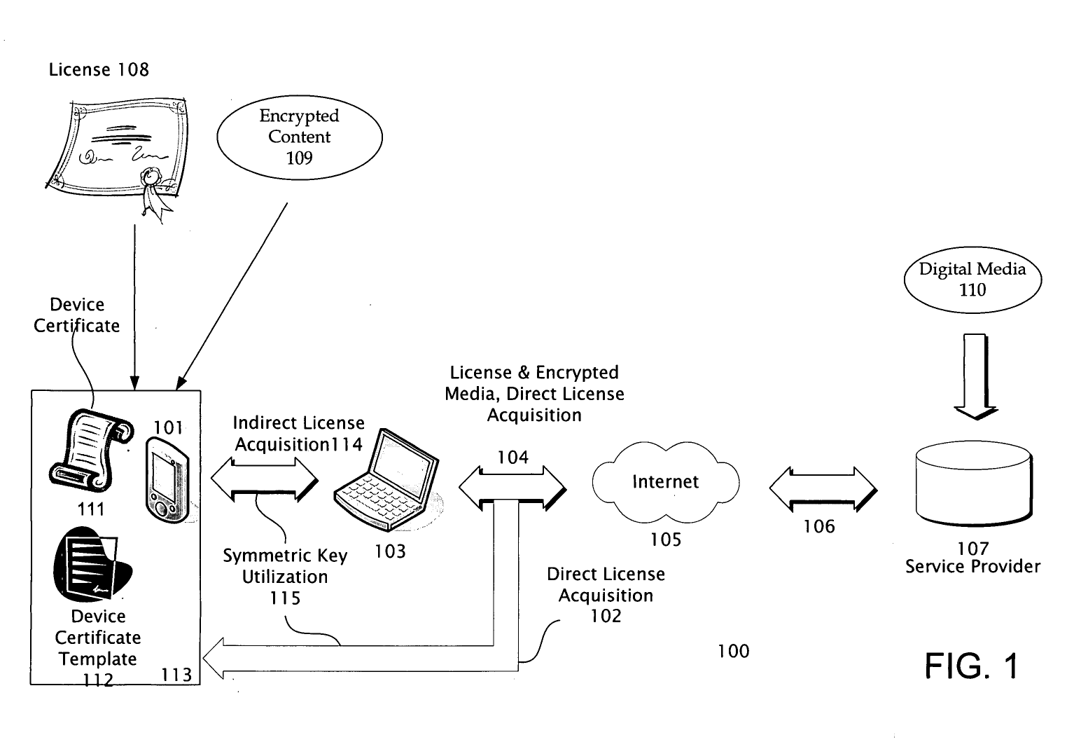

FIG. 1 is a diagram of a digital rights management system 100 that uses SKOs 115. A DRM system such as this may be used in conjunction with symmetric key optimizations. For example the communications paths shown 102, 114 may utilize symmetric key optimizations 115, that will be described later, in their operation. Other systems may utilize SKOs, and the present example is provides as an illustration of the typical operation of a system in which SKOs may be used.

Digital rights management (DRM) provides a system for defining, incorporating, and enforcing rights to digital media 110. A DRM system 100 provides secure distribution of multimedia content 110 from a service provider 107 over insecure channels such as the Internet 105. The system 100 can enforce usage rules and protect the multimedia content 110 from being used illegally. Usage rules can include expiration dates, the number of times a user can play an audio or video file, and the number of times a user can copy an audio or video file and the like. An example of a Digital Rights Management system is provided in U.S. patent application Ser. No. 09/290,363, filed Apr. 12, 1999, U.S. patent applications Ser. Nos. 10/185,527, 10/185,278, and 10/185,511, each filed on Jun. 28, 2002 which are hereby incorporated by reference in its entirety.

A personal computer 103 may be used to connect to the internet 105 and transfer content from the service provider 107 to a consumer electronics device 101. Protocols for transferring information to the PC 103, and to the CE device 101 over paths 102 and 104 may be achieved by conventional connections such as USB, infrared, Blue Tooth, MTP and the like. In alternative embodiments a consumer electronics device may be coupled to a service provider 114 without using the personal computer 103. The personal computer and the CE devices may operate utilizing any number of suitable operating systems known to those skilled in the art. The instructions for implementing the functions described in this application may exist as software, hardware (for example instructions burned into an ASIC), or a combination of both.

In typical use, DRM 100 protects contents 110 by providing encrypted data files 109. Since files 109 are encrypted, the data itself is protected. Thus, the files 109 may be moved, archived, copied, or distributed without restriction. There is no need to hide files or make them inaccessible, or to put special protection in place when files are transmitted from system to system. However, copying a file and giving it to a friend will not enable that friend to use the file. In order to be able to use an encrypted file, users must obtain a license 108. This license 108 is a way of exercising control over the encrypted file 110. A license 108 is typically granted to a single machine 101, and even if copied, it will not tend to function on other machines.

Each license 108 contains rights and restrictions, defining how the data in a file may be used, and under what conditions. For example, a music file license may contain a “right to play” but not a “right to burn to CD”, and it might enable these rights for the period between Oct. 1, 2005 and Nov. 1, 2005. It is also possible that there will be multiple licenses for a file. As long as one of those licenses grants the needed right, the user will be able to access and use their data. Access may refer to cryptographically decrypting a file, gaining access to a file by password, and the like so that the consumer electronics device can, view, play and otherwise use the content of the file.

In the embodiments of the invention described the license 108 works in conjunction with a device certificate 111 that allows the encrypted content 109 to be played on a consumer electronics device 101. The file can also be viewed if the CE device provides video, or picture capabilities. Files for viewing or playback would typically include music files, picture files, video files, documents, and the like. In short anything that a service provider wishes to transmit securely over an unsecured channel. The system identifies itself through a device certificate. This exemplary XML structure, or its equivalent, describes the CE device, lists supported features, and also contains the system's public key. The device certificate 111 is unique to an individual consumer electronics device. In the example provided the unique device certificate 111 is generated from a device certificate template 112.

Consumer electronic devices 101 that regulate playback may be referred to as digital rights management (“DRM”) devices. Such devices may be part of a DRM system 100 that controls the distribution of protected content 109 and access to that content 110.

Device certificates 111 are security devices that may be used in consumer electronics devices 101 to provide security by authenticating that a device 101 is allowed to access protected content 109. Device certificates are the credentials that are trusted and relied upon by an outside entity that may cause the entity to provide content to the CE device. Such automated device authentication may be used in systems 100 designed for secure playback or use of protected media content and where digitally signed certificates 111, or the like, are used as the way of providing authentication of rights to access media content. Protected media content 109 may include music, video, text, or any content that is subject to management by conventional license agreements or the like. The exemplary device certificate 111 may be an XML object that gathers together device identification, device capabilities claims, vital info, public key info, and the like and present the information in a single digitally signed device certificate. A device certificate typically utilizes as a minimum the public key and a signature, other information included in the device certificate is optional The device certificate 111 may be signed by an OEM signing certificate (not shown), which may be a certification by the OEM that the device certificate 111 is an accurate reflection of the device 101 accompanying it, and by a third party content regulator certificate (not shown) which certifies that the OEM is authorized to create and certify DRM systems.

The examples described introduce symmetric key optimizations (“SKO”s) which typically enable a lower performance CPU equipped device 101 to operate securely and efficiently as part of a DRM system 100. Symmetric Key Optimizations refer to a mechanism to securely utilize symmetric keys 115 within a digital rights management (“DRM”) system for portable consumer electronic devices utilizing a public key infrastructure to transfer 102, 114 information between components of the system. The DRM system typically utilizes a conventional public key infrastructure (PKI) to ensure the secure playback of DRM-protected content. Security measures in DRM systems typically utilize asymmetric cryptographic operations to provide security.

Encryption

Asymmetric cryptographic operations are typically those operations that depend upon public and private keys. Asymmetric cryptographic operations tend to be computationally intense. Asymmetric cryptographic operations typically take a long time to execute on slow processors like the low-powered CPUs on many portable devices.

By comparison, symmetric cryptographic operations typically use the same key for encryption and decryption. Symmetric cryptographic operations can be executed in a fraction of the time that it typically takes to execute asymmetric operations.

By comparison, symmetric cryptographic operations, using the same key for encryption and decryption, tend to be fast, and can be executed in a fraction of the time that it typically takes to perform an asymmetric cryptographic operation. The examples provided typically enable devices having limited CPUs to be a member of a PKI-based security system, while at the same time maintaining an acceptable level of performance by using symmetric keys. The embodiments typically allow transactions having sufficient speed to provide a more satisfactory user experience, longer battery life for the CE device, and the like. In a typical DRM system there are two basic operations that may be converted from asymmetric to symmetric: encryption and digital signatures.

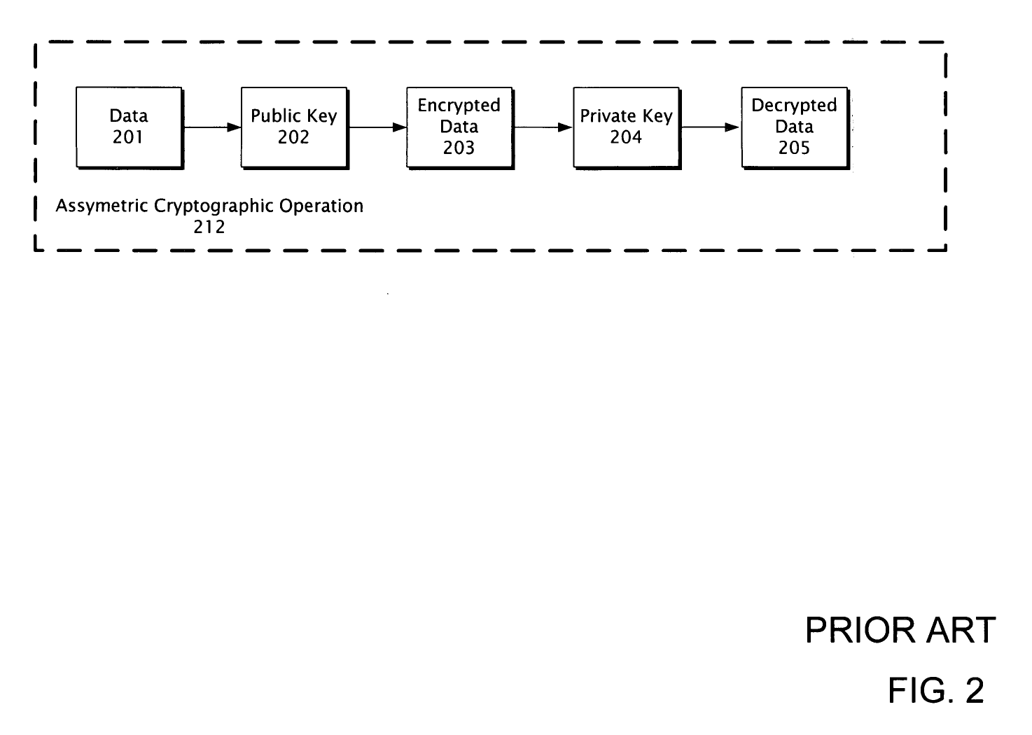

FIG. 2 illustrates the conventional process of Asymmetric key utilization. In atypical PKI 212 data 201 may be encrypted with a public key 202 to produce encrypted data 203 and decrypted with a private key 204 to return decrypted data 205.

For example, in a typical PKI, data (DATA) 201 is encrypted with the device public key (Dpub) 202. The data is later decrypted with the device private key (Dpriv) 204 as follows:

Encrypt: E Dpub(DATA)

Decrypt: D Dpriv(E Dpub(DATA))

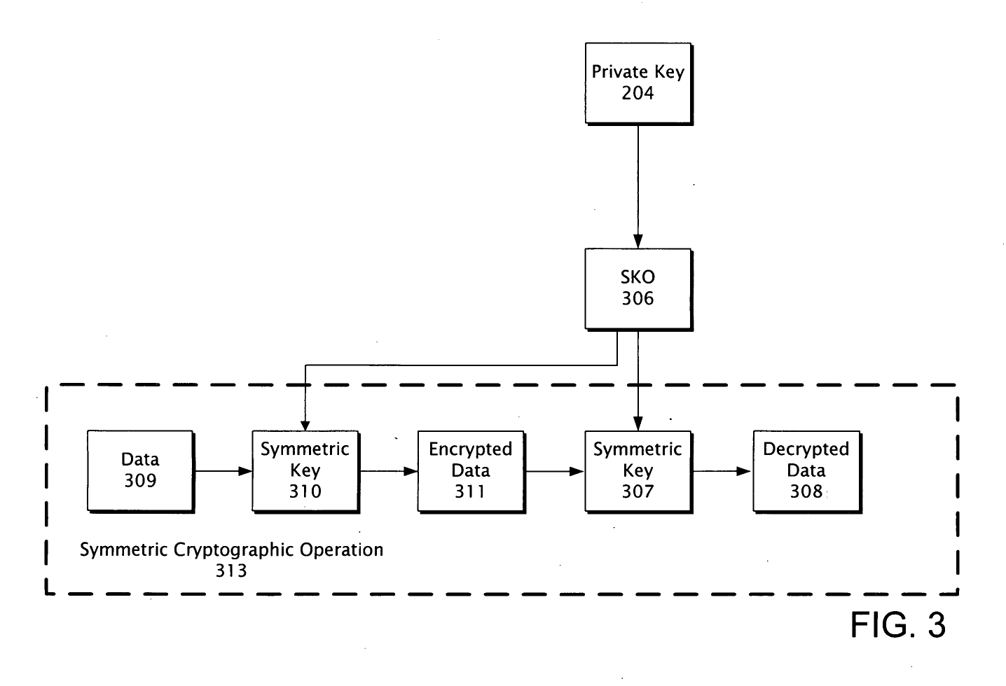

FIG. 3 illustrates the process of symmetric key optimization 313. Methods for converting encryption operations and digital signatures from asymmetric 212 (of FIG. 2) to symmetric 313 are utilized in symmetric key optimizations (“SKOs”) 306. However, in symmetric key optimization 313 the SKOs 306 generate a symmetric key, which is used in two places 307 310 and is securely derived from the private key 204 (of FIG. 2). The symmetric key is then used both to encrypt and decrypt the data.

After the SKOs 306 are applied, the data is encrypted and decrypted with the symmetric key generated by the SKO 306, which is also termed a device symmetric key (“Dsymm”). Dsymm is applied at 307 and 310. The device symmetric key is typically derived from the device private key using a secure one-way function during SKO processing at 306.

In the symmetric key optimization, after the SKOs are applied to encrypt data, the data is no longer encrypted with the public key nor decrypted with the private key. Instead, the data is encrypted and decrypted with the device symmetric key (Dsymm) which is derived from device private key (Dpriv) by the SKO 206 as follows:

Form symm key: Dsymm=SecureOneWayFunction (Dpriv)

Encrypt: E Dsymm(DATA)

Decrypt: D Dsymm(E Dsymm(DATA))

In practice, the SecureOneWayFunction is typically SHA-1, but it could be any algorithm that does not allow one to derive Dpriv from Dsymm.

Digital Signatures

To protect the integrity of data, a digital signature can often be applied. Any changes to the data would cause the digital signature to fail the verification step. The SKOs use a symmetric signature to accomplish the same thing. The symmetric signature uses an HMAC (Hashed MAC), which is essentially a one-way hash secured by a key. Other equivalent functions may be utilized. The key used for the hash is derived from the CE device.

For example, in a typical asymmetric cryptographic operation, a collection of data (DATA) would be signed by a private key (Spriv) and later verified using the corresponding public key (Spub) as follows:

Sign: Signature=Spriv(DATA)

Verify: Verify Spub(DATA, Signature)

After applying the SKOs, the data integrity typically depends (as is the case for symmetric device certificate signature verification) upon the symmetric key (Ssymm) which is derived from Spriv:

Form symm key: Ssymm=SecureOneWayFunction (Spriv)

Sign: Signature=HMAC(Ssymm, DATA)

Verify: Verify HMAC(Ssymm, DATA)==Signature

Note that because both the signing and verification steps may require knowledge of the signing private key, the SKO is typically only usable within a secure environment. In other words, Party A can not symmetrically sign a message and then have Party B verify the signature. The asymmetric PKI would be used for this purpose. In particular, for license signatures the data may be signed with LicenseServerPrivateKey and optimized using the DeviceSKO which may be derived from DevicePrivateKey.

Symmetric Key Optimizations

In conventional CE systems, acquiring DRM licenses and playing DRM content may require processing multiple asymmetric (ECC) operations. On many consumer electronics devices these operations were sometimes found to be too complex, often requiring an unacceptable amount of time.

Typical DRM Keys

The following is a summary of typical DRM system keys and their use. The Content Key is typically used to encrypt and or decrypt content. The Device Public/Private Key is typically used to encrypt and or decrypt the content key. It may also be used to decrypt a session key. The Session Key is typically generated on the PC, and may be used to encrypt and or decrypt the content key. During a SetLicenseResponse, the Session Key is encrypted with the device public key. While stored in the secure store, it is typically encrypted with the device symmetric key. The Device Symmetric Key is typically derived from the device private key. It may be used to symmetrically sign the license before it is stored on the device.

Indirect License Acquisition (“ILA”)

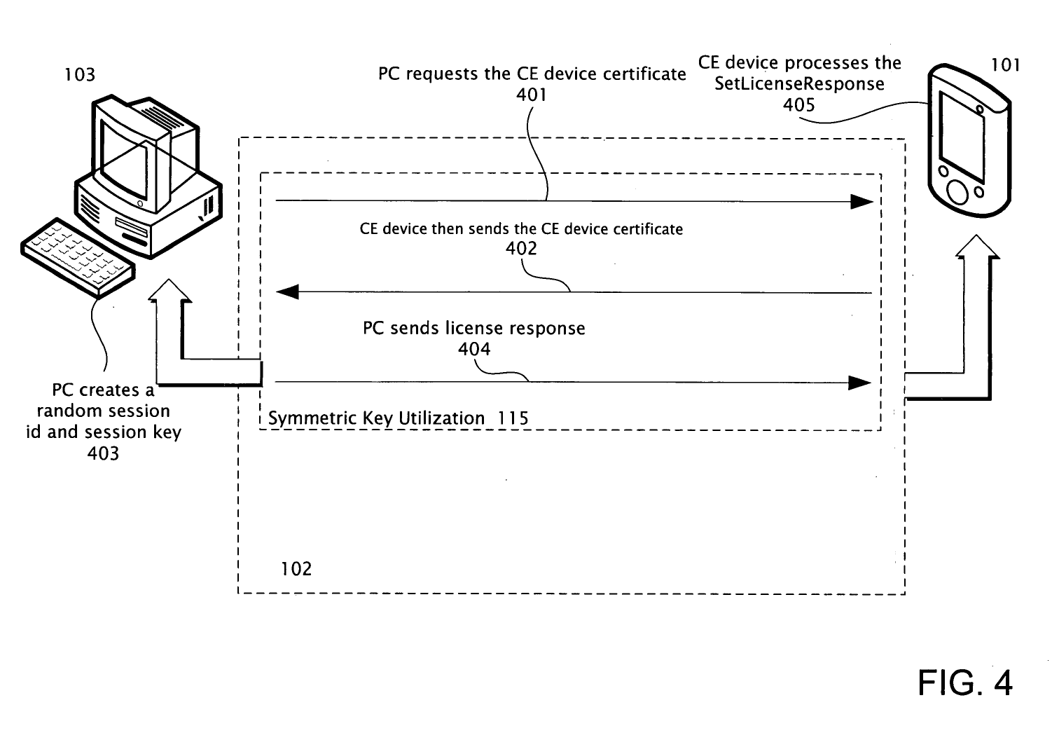

FIG. 4 illustrates the exchange between a PC and the CE device that utilizes symmetric keys produced by symmetric key optimization. An exchange of this type that utilizes a PC as an intermediary between the CE device and the service provider may be termed an indirect license acquisition (“ILA”). An example of this exchange path is shown at 102 (of FIG. 1). Symmetric keys may be utilized during ILA copying of DRM licenses. The PC requests the CE device certificate 401. The CE device then sends the CE device certificate 402, which is validated by the PC. The PC creates a random session id and session key 403. The PC encrypts the session key with the device public key. The device public key is taken from the device certificate. Verification and receipt of CE license is performed at the CE device by responding to a SetLicenseResponse sent by the PC at 404. The CE device processes the SetLicenseResponse 405.

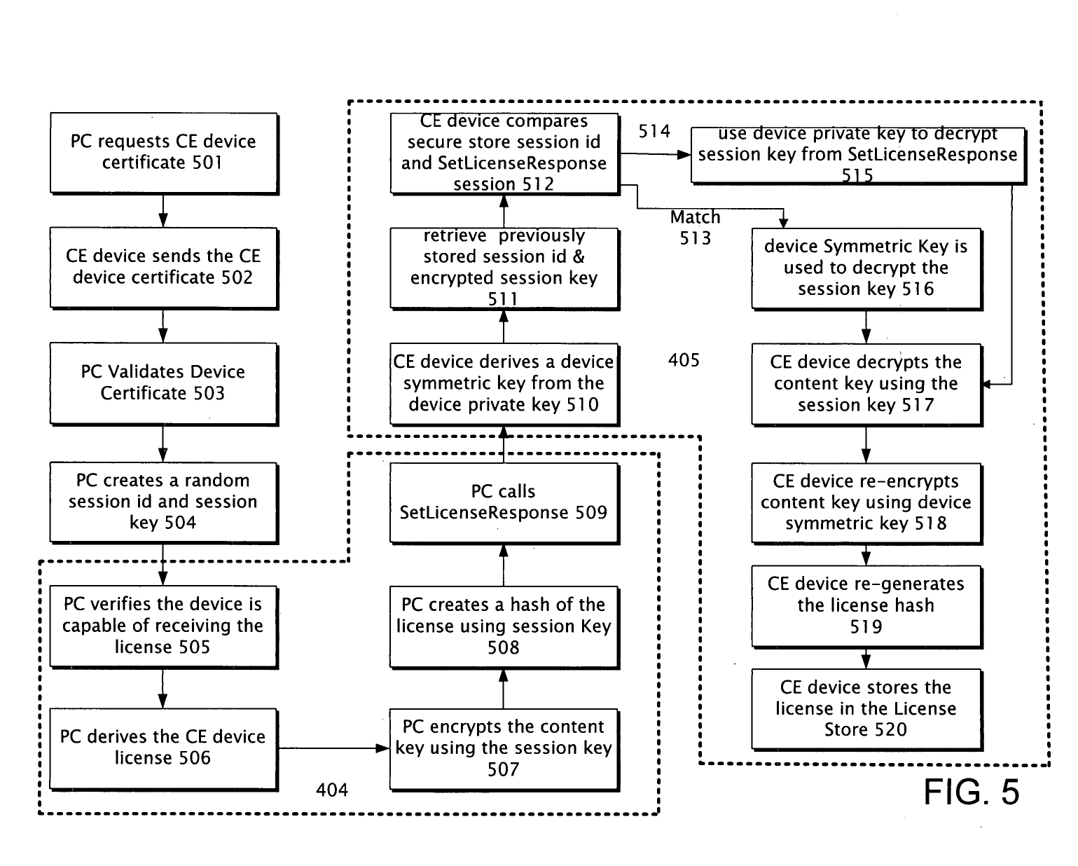

FIG. 5 is a flow diagram showing the process of the exchange between the PC and the CE device utilizing symmetric keys produced by symmetric key optimization. In the process the PC requests the CE device certificate 501. The CE device then sends the CE device certificate. And the PC validates by checking against the certificate revocation list 503 The certificate revocation list tracks devices that may be revoked, so that a PC will no longer issue it a license. The PC creates a random session id and session key 504, in which the PC encrypts the session key with the device public key (from the device certificate).

The following occurs during step block 404 (of FIG. 4), assuming the AllowCopy right is set. The presence of AllowCopy right is the indicator provided to show that permission to copy the file is granted to a user. First the PC verifies the CE device is capable of receiving the license. (i.e.: supports required features—Metering, Expiration, etc) 505. The PC derives the CE device license that is suitable for the device with similar or a subset of rights 506. The PC encrypts the content key at 507 using the session key, created on the PC in 503. The PC creates a hash of the license using SHA-1 and HMAC using the session key 508. The PC calls SetLicenseResponse on the CE Device via a media transfer protocol 509. As part of the parameters, SetLicenseResponse includes the Session Key and Session Id, along with the DRM License.

The CE device processes the SetLicenseResponse 405 (of FIG. 4) as described below. The CE device derives a device symmetric key from the device private key using the SHA-1 algorithm 510.

The CE device will retrieve from the secure store the previously stored session id and encrypted session key (encrypted with the device symmetric key) 511. The CE device compares the session id in the secure store and the session id in the SetLicenseResponse 512. Based on whether they match, the device will take the following actions.

If they do not match 514 the device private key is used to decrypt the session key from the SetLicenseResponse at block 515. It will re-encrypt the session key using the device Symmetric Key and store the session id and re-encrypted Session Key in the secure store.

If the session IDs match 513, the device Symmetric Key is used to decrypt the session key retrieved from the secure store at block 516.

The CE device decrypts the content key using the session key (received in step #3) at block 517. The CE device re-encrypts the content key using the device symmetric key at block 518. The CE device re-generates the license hash using SHA-1 and HMAC using the device symmetric key at block 519. The CE device stores the license in the License Store at block 520.

Direct License Acquisition (“DLA”)

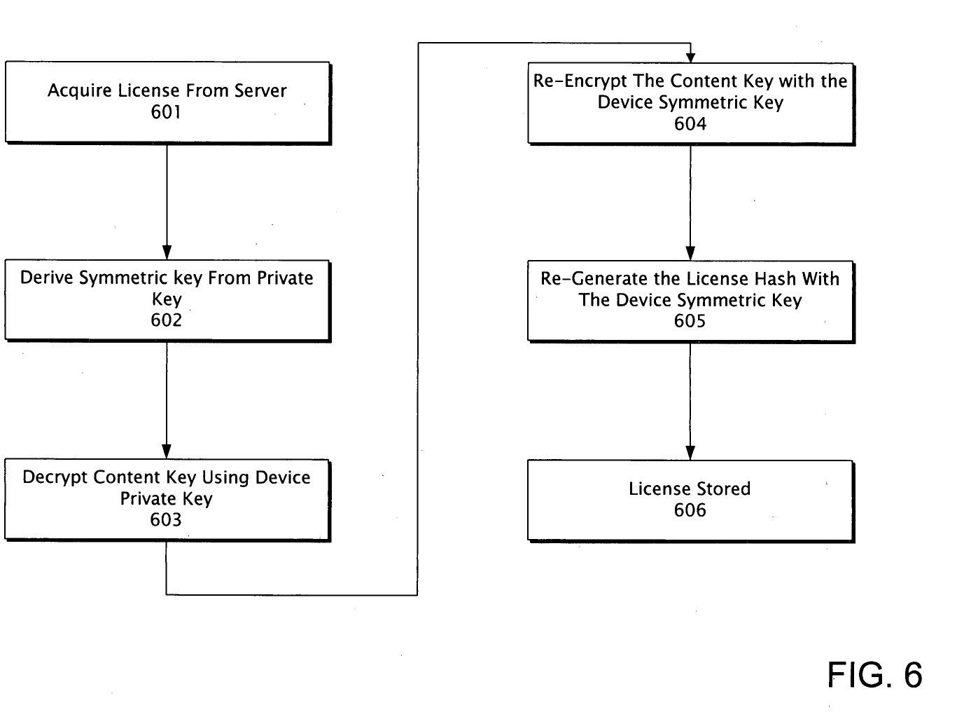

FIG. 6 is a flow diagram showing the process of the exchange between the internet and the CE device utilizing symmetric keys produced by symmetric key optimization. A direct exchange such as this, that does not utilize a PC as an intermediary, may be termed a direct license acquisition. An example of this acquisition path is shown at 114 in FIG. 1. The DLA process may be used for devices that acquire licenses directly over the internet (see 114 of FIG. 1)

First the CE device acquires a license from a WMRM SDK based license server using the existing DLA protocol 601. The CE device then derives a device symmetric key from the device private key using the SHA-1 algorithm 602. The CE device decrypts the content key using the device private key 603. The CE device re-encrypts the content key using the device symmetric key 604. The device first verifies the existing asymmetric signature using the license server public key before it creates the symmetric signature. The device then re-generates the license hash using SHA-1 and HMAC using the device symmetric key 605. Finally the device stores the license in the License Store 606.

DRM Initialization

Before decrypting and playing back DRM content, first the DRM system on the CE device may be called to find a suitable license (via the bind API) and commit to using that license (via the commit API).

Included below is a summary of the changes during a typical commit call. Symmetric keys may be accommodated by utilizing the following changes from a conventional bind call:
The CE device may derive a device symmetric key from the device private key using the SHA-1 algorithm.
The CE device may decrypt the content key using the device symmetric key
The CE device may verify the hash created with SHA-1 and HMAC with the content key is valid to attempt to ensure that the license has not been tampered with.
Other steps may be performed, such as verifying the requested right is available, and if the license requires state that the state is not exhausted.

Typically after these adjustments to the conventional commit call are complete, a CE device can proceed with decrypting content. Further Alternative Examples Utilizing Symmetric Keys
1. Device Certificate Signing

Further alternative examples may be provided by utilizing device certificate signing. As may be typically done, the CE device may sign the device certificate with the device certificate signing private key. The signature of the device certificate typically will be later verified by the PC and/or License Server to confirm the device certificate hasn't been tampered with. The CE device may also sign the device certificate with a HMAC and the device certificate signing symmetric key derived from the device certificate signing private key.

In a yet further alternative example when a CE device is initialized it may verify the device certificate has not been tampered with using the device certificate signing symmetric key
2. Certificate Chain Verification

When the DRM system encounters a certificate, such as a certificate used to verify the license signature, a metering or secure clock certificate, it typically verifies that the certificate is signed by a trusted source such as the service provider.

Multiple PKI digital signature operations to verify the certificate chain up to the Microsoft certificate may be performed. However, once the certificate has been verified, a signature of the certificate (based on hash and HMAC) may be stored in the secure store.

The DRM system may also check the secure store first to see if it has previously verified the certificate chain for a certificate by querying the secure store. If this has been done, it will not proceed with the PKI digital signature operations.

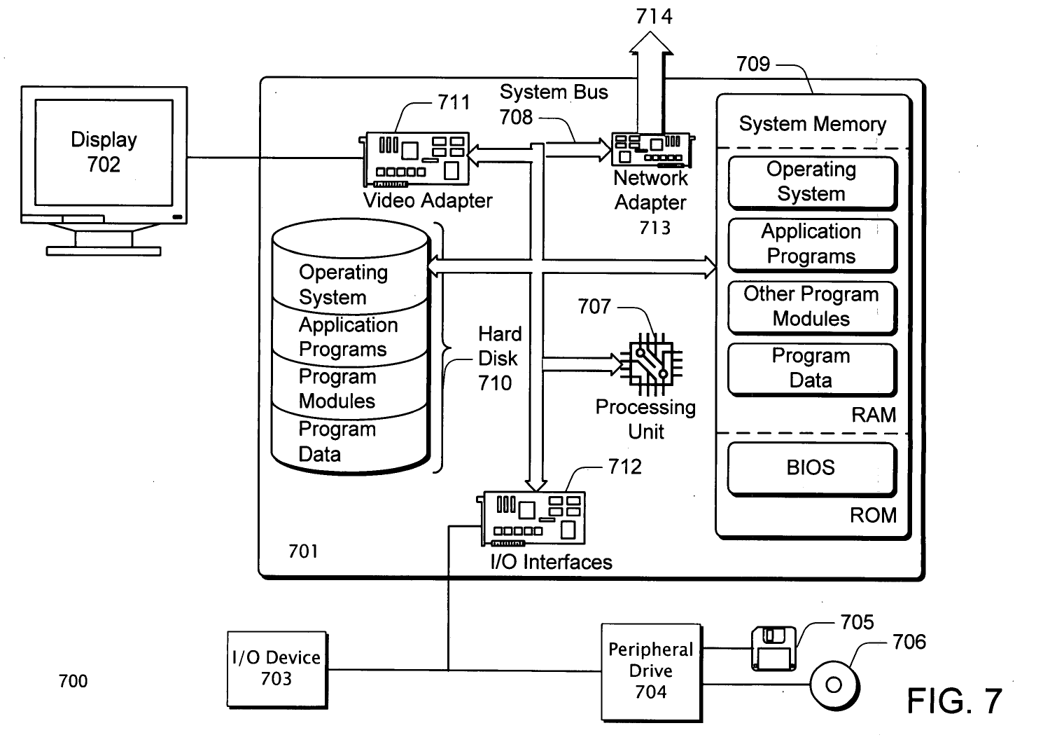

FIG. 7 illustrates an exemplary computing environment 700 in which the systems and methods described in this application, may be implemented. For example, the components shown here may be part of the CE device 101 (of FIG. 1), or the CPU 103 (of FIG. 1) Exemplary computing environment 700 is only one example of a computing system and is not intended to limit the examples described in this application to this particular computing environment.

The computing environment 700 can be implemented with numerous other general purpose or special purpose computing system configurations. Examples of well known computing systems, may include, but are not limited to, personal computers, hand-held or laptop devices, microprocessor-based systems, multiprocessor systems, set top boxes, programmable consumer electronics, gaming consoles, Consumer electronics, cellular telephones, PDAs, and the like.

The computer 700 includes a general-purpose computing system in the form of a computing device 701. The components of computing device 701 can include one or more processors (including CPUs, GPUs, microprocessors and the like) 707, a system memory 709, and a system bus 708 that couples the various system components. Processor 707 processes various computer executable instructions to control the operation of computing device 701 and to communicate with other electronic and computing devices (not shown). The system bus 708 represents any number of several types of bus structures, including a memory bus or memory controller, a peripheral bus, an accelerated graphics port, and a processor or local bus using any of a variety of bus architectures.

The system memory 709 includes computer-readable media in the form of volatile memory, such as random access memory (RAM), and/or non-volatile memory, such as read only memory (ROM). A basic input/output system (BIOS) is stored in ROM. RAM typically contains data and/or program modules that are immediately accessible to and/or presently operated on by one or more of the processors 707.

Mass storage devices 704 may be coupled to the computing device 701 or incorporated into the computing device by coupling to the buss. Such mass storage devices 704 may include a magnetic disk drive which reads from and writes to a removable, non volatile magnetic disk (e.g., a “floppy disk”) 705, or an optical disk drive that reads from and/or writes to a removable, non-volatile optical disk such as a CD ROM or the like 706. Computer readable media 705, 706 typically embody computer readable instructions, data structures, program modules and the like supplied on floppy disks, CDs, portable memory sticks and the like.

Any number of program modules can be stored on the hard disk 710, Mass storage device 704, ROM and/or RAM 709, including by way of example, an operating system, one or more application programs, other program modules, and program data. Each of such operating system, application programs, other program modules and program data (or some combination thereof) may include an embodiment of the systems and methods described herein.

A display device 702 can be connected to the system bus 708 via an interface, such as a video adapter 711. Such a video adapter may include sound capability, or in the case of a CE device may only provide sound to a speaker. A user can interface with computing device 702 via any number of different input devices 703 such as a keyboard, pointing device, joystick, game pad, serial port, and/or the like. These and other input devices are connected to the processors 707 via input/output interfaces 712 that are coupled to the system bus 708, but may be connected by other interface and bus structures, such as a parallel port, game port, and/or a universal serial bus (USB).

Computing device 700 can operate in a networked environment using connections to one or more remote computers through one or more local area networks (LANs), wide area networks (WANs) and the like. The computing device 701 is connected to a network 714 via a network adapter 713 or alternatively by a modem, DSL, ISDN interface or the like.

Those skilled in the art will realize that storage devices utilized to store program instructions can be distributed across a network. For example a remote computer may store a tool such as the adaptive instrumentation runtime monitoring and analysis software. A local or terminal computer may access the remote computer and download a part or all of the software to run the program. Alternatively the local computer may download pieces of the software as needed, or distributively process by executing some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Those skilled in the art will realize that storage devices utilized to store program instructions can be distributed across a network. For example a remote computer may store an example of the process described as software. A local or terminal computer may access the remote computer and download a part or all of the software to run the program. Alternatively the local computer may download pieces of the software as needed, or distributively process by executing some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

1. A method of symmetric encryption comprising:
transforming a private key to a symmetric key by applying a symmetric key optimization;
encrypting data with the symmetric key; and
decrypting data with the symmetric key.

2. The method of symmetric encryption of claim 1, in which the symmetric key optimization is performed by applying a secure one-way function to the private key.

3. The method of symmetric encryption of claim 2, in which the secure one way function is SHA-1.

4. The method of symmetric encryption of claim 3, in which the secure one way function does not allow the private key to be derived from the symmetric key.

5. A method of providing symmetric digital signatures comprising:
transforming a private key to a symmetric key by applying a secure one way function; and
signing a file by applying a HMAC function to the symmetric key and the file.

6. The method of providing symmetric digital signatures of claim 5, in which the HMAC function is a one way function secured by a key.

7. The method of providing symmetric digital signatures of claim 5, further comprising verifying that the HMAC of the symmetric key and the data produces a correct digital signature.

8. The method of providing symmetric digital signatures of claim 7, in which signing and verifying are performed in a secure environment.

9. The method of providing symmetric digital signatures of claim 7, in which the secure environment is a DRM system.

10. A method of indirect license acquisition comprising:
requesting a device certificate from a CE device by a PC;
validating the device certificate sent from the CE device by the PC;
creating a random session ID and a session key by the PC;
generating a license response that is sent to the CE device; and
processing a license response by the CE device.

11. The method of indirect license acquisition of claim 10, in which generating a license response further comprises the PC verifying the CE device is capable of receiving the license.

12. The method of indirect license acquisition of claim 10, in which generating a license response further comprises the PC encrypting a content key using the session key.

13. The method of indirect license acquisition of claim 10, in which generating a license response further comprises the PC creating a hash of a license.

14. The method of indirect license acquisition of claim 10, in which processing a license response by the CE device further comprises the CE device deriving a device symmetric key from a device private key.

15. The method of indirect license acquisition of claim 14, in which deriving a device symmetric key from a device private key is performed by applying a SHA-1 process.

16. The method of indirect license acquisition of claim 10, in which processing a license response by the CE device further comprises the CE device comparing a first session id from a secure store and a second session id from the SetLicenseResponse.

17. The method of indirect license acquisition of claim 16, in which the device symmetric key is used to decrypt the session key if the first session id from a secure store and the second session id from the SetLicenseResponse match.

18. The method of indirect license acquisition of claim 17, in which the device private key is used to decrypt the session key from the SetLicenseResponse if the first session id from a secure store and the second session id from the SetLicenseResponse do not match.

19. The method of indirect license acquisition of claim 17, in which the CE device decrypts the session key using the content key.

20. The method of indirect license acquisition of claim 19, in which the CE device re-encrypts the content key using the device symmetric key, the CE device re-generates the license hash, and the CE device stores the license in the license store.
